(19) United States
(12) Patent Application Publication
(10) Pub. No.: US 2026/0127851 A1
(43) Pub. Date: May 7, 2026

(54) SIGNAL PROCESSING SYSTEM, SIGNAL PROCESSING METHOD, AND SIGNAL PROCESSING PROGRAM

(71) Applicant: NEC Corporation, Tokyo (JP)

(72) Inventor: Taichi TANAKA, Tokyo (JP)

(73) Assignee: NEC Corporation, Tokyo (JP)

(21) Appl. No.: 19/365,313

(22) Filed: Oct. 22, 2025

(30) Foreign Application Priority Data
Nov. 6, 2024 (JP) 2024-194070

(51) Int. Cl. G06V 10/762; G06V 10/74

(52) U.S. Cl. CPC G06V 10/762; G06V 10/761

(57) ABSTRACT

The signal processing system includes an assignment unit that assigns each pixel to a cluster in such a way as to maximize a complex metric that indicates a degree of match between a complex vector obtained from corresponding pixels of a plurality of complex images and a probability parameter of a cluster, and a parameter calculation unit that calculates, for each cluster, the probability parameter in such a way as to maximize the complex metric for all pixels assigned to the cluster, wherein the assignment unit and the parameter calculation unit operate alternately.

This application is based upon and claims the benefit of priority from the prior Japanese Patent Application No. 2024-194070, filed Nov. 6, 2024, the entire contents of which are incorporated herein by reference.

### BACKGROUND OF INVENTION

### Field of the Invention

This disclosure relates to a signal processing system, a signal processing method, and a signal processing program.

### Description of the Related Art

As a technique related to signal processing, for example, Patent Literature 1 describes a technique for extracting statistically homogeneous pixels from a SAR (Synthetic Aperture Radar) image obtained using SAR technology.

The pixel identification device described in Patent Literature 1 assumes that the pixel of interest and a neighboring pixel follow the same probability distribution when the maximum absolute value of a difference between a cumulative density function related to the pixel of interest and a cumulative density function related to the neighboring pixel is smaller than a predetermined threshold. That is, the pixel identification device assumes that the pixel of interest and the neighboring pixel are generated by the same probability density function and determines that the neighboring pixel is statistically a pixel homogeneous with the pixel of interest.
[Patent Literature 1] WO 2010/112426

### SUMMARY OF INVENTION

A SAR image is a complex image in which each pixel has information of reflection intensity of irradiated microwaves and information of phase. However, in the invention described in Patent Literature 1, although statistically homogeneous pixels are extracted, similarity of phase between pixels is not considered. Therefore, pixels whose phases are not similar may be mixed in the extracted pixel group. As a result, when these pixel groups are used in analysis of phase, the analysis result may become inaccurate.

The present disclosure has been made in view of these problems. An example object of the disclosure is to provide a signal processing system, a signal processing method, and a signal processing program that can suitably extract a pixel group from a complex image.

A signal processing system according to an example aspect of the disclosure includes an assignment unit that assigns each pixel to a cluster in such a way as to maximize a complex metric that indicates a degree of match between a complex vector obtained from corresponding pixels of a plurality of complex images and a probability parameter of a cluster, and a parameter calculation unit that calculates, for each cluster, the probability parameter in such a way as to maximize the complex metric for all pixels assigned to the cluster, wherein the assignment unit and the parameter calculation unit operate alternately.

A signal processing method according to an example aspect of the disclosure includes assigning each pixel to a cluster in such a way as to maximize a complex metric that indicates a degree of match between a complex vector obtained from corresponding pixels of a plurality of complex images and a probability parameter of a cluster, calculating, for each cluster, the probability parameter in such a way as to maximize the complex metric for all pixels assigned to the cluster, and alternately performing the assigning and the calculating.

A signal processing program according to an example aspect of the disclosure for causing a computer to execute assigning each pixel to a cluster in such a way as to maximize a complex metric that indicates a degree of match between a complex vector obtained from corresponding pixels of a plurality of complex images and a probability parameter of a cluster, calculating, for each cluster, the probability parameter in such a way as to maximize the complex metric for all pixels assigned to the cluster, and alternately performing the assigning and the calculating.

According to the present disclosure, a pixel group can be suitably extracted from a complex image.

### BRIEF DESCRIPTION OF THE DRAWINGS

FIG. 1 It depicts a block diagram that explains a signal processing device.

FIG. 2 It depicts an explanatory diagram that explains an example of a SAR image.

FIG. 3 It depicts a flowchart that explains an example of operation of the signal processing device.

FIG. 4 It depicts a flowchart that explains another example of operation of the signal processing device.

FIG. 5 It depicts a block diagram that explains a signal processing device.

FIG. 6 It depicts a block diagram that explains a signal processing system.

FIG. 7 It depicts a flowchart that explains operation of the signal processing system.

FIG. 8 It depicts a block diagram that explains a signal processing system.

FIG. 9 It depicts a block diagram that explains operation of the signal processing system.

FIG. 10 It depicts a block diagram that explains a hardware configuration of a computer.

FIG. 11 It depicts a block diagram that explains principal parts of a signal processing system.

### DESCRIPTION OF THE PREFERRED EMBODIMENTS

SAR (Synthetic Aperture Radar) technology is a technology in which a flying object such as a satellite or an aircraft transmits and receives electromagnetic waves while moving, and obtains a SAR image equivalent to an image by an antenna having a large aperture. SAR is used, for example, to analyze ground displacement and the like by signal processing of reflection waves from the ground. Note that the ground includes not only the earth surface but also a surface, such as a top surface, on which low structures such as buildings exist.

An image photographed by a flying object such as a satellite is called a radar image. A SAR image is one example of a radar image. Below, assume that the flying object that transmits and receives electromagnetic waves is a satellite, but the flying object is not limited to a satellite.

As one example of image analysis, there is interferometric analysis that analyzes displacement, elevation, and the like based on a phase difference among a plurality of SAR images. As another example of image analysis, there is change detection that detects a change or an anomaly on the ground based on a change in intensity. Note that these are merely examples of image analysis, and the field of image analysis is wide ranging.

Various natural and artificial objects are imaged in a SAR image. Therefore, pixel values at respective pixels in a plurality of pixels in a SAR image may have different properties depending on an object imaged by the pixel. In particular, it is known that probabilistic variation of pixel values, that is, noise, has different characteristics depending on a type of subject. Therefore, there is a problem that a result by image analysis becomes inaccurate when characteristics dependent on the type of subject are not considered.

To solve such a problem, it is useful to extract statistically homogeneous pixels. For example, Patent Literature 1 describes a technique for extracting statistically homogeneous pixels.

However, the pixel identification device described in Patent Literature 1 does not consider similarity of phase between pixels when extracting pixels. Therefore, pixels whose phases are not similar may be mixed in the extracted pixel group. As a result, when these pixel groups are used in analysis of phase, the analysis result may become inaccurate. In addition, the pixel identification device described in Patent Literature 1 performs comparisons with all pixels in a window for each of a large number of pixels of interest, so that an enormous computation time is required. That is, time is required to obtain a statistically homogeneous pixel group. The present disclosure has been made in view of these problems.

Below, example embodiments of the present disclosure are explained with reference to drawings. In the drawings, the same or corresponding elements are denoted by the same reference numerals, and redundant explanation is omitted as needed for clarity of explanation. Unless particularly explained, values predetermined such as a predetermined value or a threshold are previously stored in a storage device accessible by a device that uses the values. Unless particularly explained, a storage unit is configured by one or more arbitrary numbers of storage devices.

In each example embodiment explained below, a SAR image is used as a radar image obtained using electromagnetic waves. However, a radar image is not limited to a SAR image. For example, the radar image may be an optical image. Also, a SAR image is a complex image in which each pixel has, as a pixel value, information of reflection intensity of irradiated microwaves and information of phase. Below, a SAR image is also written as a complex image.

### Example Embodiment 1

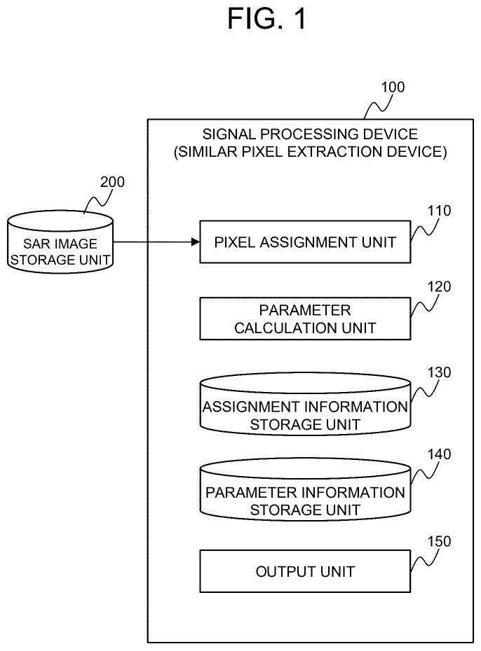

FIG. 1 is a block diagram that explains a signal processing device. A signal processing device 100 of the present example embodiment includes a pixel assignment unit 110, a parameter calculation unit 120, an assignment information storage unit 130, a parameter information storage unit 140, and an output unit 150. The signal processing device 100 can input SAR images from a SAR image storage unit 200. Note that the SAR image storage unit 200 may be included in the signal processing device 100 or may be included in a device different from the signal processing device 100.

The signal processing device 100 is a signal processing device in a signal processing system that extracts similar pixels in a SAR image, that is, a similar pixel extraction device. Note that, also in other example embodiments explained later, the signal processing device constitutes a similar pixel extraction device that extracts similar pixels in a SAR image.

The pixel assignment unit 110 has a function to assign each pixel of a SAR image to a cluster. For example, the pixel assignment unit 110 assigns each pixel to a cluster in such a way as to maximize a complex metric that indicates a degree of match between a complex vector obtained from corresponding pixels of a plurality of complex images and a probability parameter of a cluster

The parameter calculation unit 120 has a function to calculate probability parameters of clusters. For example, the parameter calculation unit 120 calculates, for each cluster, the probability parameter in such a way as to maximize the complex metric for all pixels assigned to the cluster,

The assignment information storage unit 130 stores assignment information that indicates pixels assigned to clusters by the pixel assignment unit 110. The assignment information includes, for example, information that indicates an association between a cluster and pixels assigned to the cluster. Below, a pixel assigned to a cluster is also called a pixel belonging to the cluster.

The parameter information storage unit 140 stores parameter information that indicates probability parameters for each cluster calculated by the parameter calculation unit 120.

The output unit 150 has a function to output the assignment information and the parameter information. The output unit 150 outputs, for example, the assignment information and the parameter information to a storage unit of the signal processing device 100 or an external device (not shown) to store them. The output unit 150 also outputs, for example, the assignment information and the parameter information to a display device such as a display device (not shown) to display them. The output unit 150 may output only one of the assignment information and the parameter information or may output both.

The SAR image storage unit 200 stores S SAR images (for example, S=approximately 10 to 30) in which the same region is photographed. In other words, the SAR image storage unit 200 stores S SAR images in which a common analysis region appears. Below, SAR images stored in the SAR image storage unit 200 (a group of SAR images) are also called input SAR images or an input SAR image group. The SAR images are aligned in such a way that pixels at the same positions in respective SAR images become pixels of the same location or object.

In FIG. 1, arrows schematically indicate flows of signals (data), but bidirectionality is not excluded. This also applies to other block diagrams.

The S SAR images are radar images in which the same region is recorded and which are obtained at different times or orbits. The SAR images stored in the SAR image storage unit 200 may be images obtained at different times but at the same orbit. A plurality of SAR images may be images obtained at different orbits but at the same time. Further, a plurality of SAR images may be images in which both acquisition time and acquisition orbit are different.

Imaging conditions (acquisition time, incidence angle, band, and the like) are not limited to conditions at actual photographing and may be artificially synthesized. For example, in a photographing method called polarimetric SAR, characteristics dependent on an electric field direction of electromagnetic waves can be obtained by controlling conditions (polarimetric imaging conditions) such as the electric field direction of irradiated electromagnetic waves and sensitivity and phase delay of an antenna with an electric field direction when receiving electromagnetic waves. In this photographing method, an image photographed under arbitrary polarimetric conditions can be reproduced by synthesizing images photographed under approximately two to three different polarimetric conditions.

Even in ordinary SAR that is not polarimetric SAR, an image of only a part of a band can be extracted by performing a transform process to a frequency domain such as Fourier transform on a SAR image after photographing and performing a filter process to extract a part of the band. The filter process that extracts a part of the band may be a process that randomly extracts a part or may be a filter process that randomly excludes a part.

By using the above techniques, a SAR image group photographed at a plurality of different bands can be constructed. That is, an image of an imaging condition that is not physically used can be generated to construct a SAR image group.

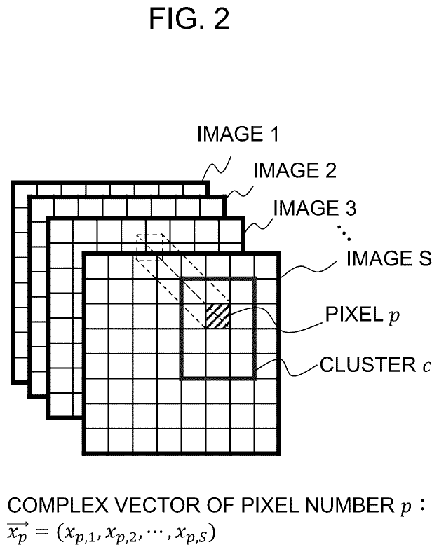

FIG. 2 is an explanatory diagram that explains one example of SAR images. In FIG. 2, S SAR images from image 1 to image S are shown. Each SAR image is aligned in such a way that pixels at the same positions become pixels of the same location or object.

A complex vector in the present disclosure is a feature vector obtained from corresponding pixels of a plurality of SAR images. Corresponding pixels are pixels at the same position in respective SAR images and are pixels of the same location or object. In this specification, the term “complex vector” means a vector composed of complex-valued elements (that is, a vector of complex numbers).

The complex vector has, for each of the corresponding pixels obtained when a plurality of aligned SAR images are input, a number of elements equal to the number of inputs. For example, a complex vector xₚ corresponding to pixels with pixel number p is expressed as in Equation (1) below. Note that an arrow mark denotes a vector.

$$\begin{matrix}[ Math . 1 ] & \\ \vec{{x}_{p}} = ( {x}_{p , 1} , {x}_{p , 2} , … , {x}_{p , S} ) & Equation ( 1 )\end{matrix}$$

A complex metric in the present disclosure is a metric that measures a degree to which a pixel belongs to a cluster. Below, an example is explained in which the complex metric of Equation (2) below is used.

$$\begin{matrix}[ Math . 2 ] & \\ p ( \vec{{x}_{p}} \vert {Γ}_{c} ) = \frac{1}{det ( {Γ}_{c} )} exp ( - {{x}_{p}}^{\to H} {Γ}_{c}^{- 1} \vec{{x}_{p}} ) & Equation ( 2 )\end{matrix}$$

In Equation (2), c is a cluster number to identify a cluster. Gamma_c is a probability parameter (covariance) corresponding to cluster c. p is a pixel number to identify a pixel. S is a total number of SAR images. Vector xₚ is a complex vector obtained from respective pixels corresponding to pixel number p.

Equation (2) is a probability density function based on a 0-mean multivariate complex Gaussian distribution. The signal processing device 100 uses, as a complex metric that measures the degree to which the pixel with pixel number p belongs to cluster c, a multivariate complex Gaussian with Gamma_c as a probability parameter (covariance).

Note that the complex metric available to the signal processing device 100 is not limited to that shown in Equation (2). The signal processing device 100 can use various complex metrics. However, the complex metric needs to be related to both phase and intensity as a complex number, that is, an absolute value of a complex number. Also, it is desirable that the complex metric becomes a constant irrespective of a value of the probability parameter when integrating vector xₚ.

For example, the signal processing device 100 may use Equation (3) below as the complex metric.

$$\begin{matrix}[ Math . 3 ] & \\ p ( \vec{{x}_{p}} \vert {A}_{c} ) = det ( {A}_{c} ) exp ( - {{x}_{p}}^{\to H} {A}_{c} \vec{{x}_{p}} ) & Equation ( 3 )\end{matrix}$$

In Equation (3), some elements of A_{C} are constrained to be zero. Elements constrained to zero may be associated to, for example, pairs far in date or pairs far in orbit.

In Equation (3), the probability parameter is an inverse matrix of a variance-covariance matrix, and a part of it is constrained to zero. That is, Equation (3) imposes a sparse constraint so that many elements become zero for a precision matrix that is an inverse matrix of a variance-covariance matrix. By using the complex metric shown in Equation (3), the signal processing device 100 can achieve an effect of reducing computation amount and an effect of stabilizing computation.

Also, the signal processing device 100 may use Equation (4) below as the complex metric.

$$\begin{matrix}[ Math . 4 ] & \\ p ( \vec{{x}_{p}} \vert {Γ}_{c} ) = \frac{1}{{det ( {Γ}_{c} )}^{S}} {( 1 + \frac{1}{v} {{x}_{p}}^{\to H} {Γ}_{c}^{- 1} \vec{{x}_{p}} )}^{- ( v + N )} & Equation ( 4 )\end{matrix}$$

Equation (4) is a probability density function of a multivariate complex t-distribution. In Equation (4), nu is not a probability parameter but a fixed value and is used to control robustness to outliers. By using the complex metric shown in Equation (4), the signal processing device 100 can control robustness to outliers.

In addition to the above examples, for example, the signal processing device 100 may perform processing by making a phase of vector xₚ follow a von Mises distribution and an absolute value follow a Rice distribution.

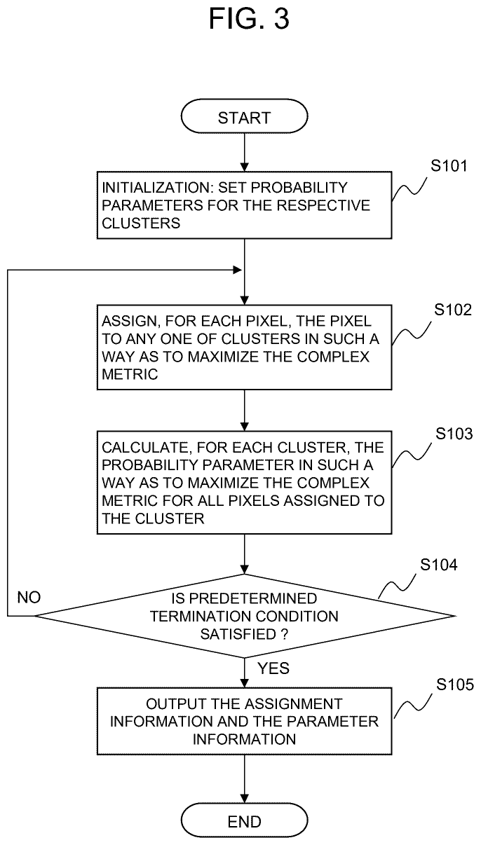

Next, the operation of the signal processing device 100 is explained. FIG. 3 is a flowchart that explains an example of operation of the signal processing device 100.

The signal processing device 100 inputs a plurality of aligned SAR images and executes initialization processing. That is, the signal processing device 100 divides SAR images into a plurality of initial clusters. A way of division is arbitrary. As one example, the signal processing device 100 creates a plurality of initial clusters in such a way that areas of clusters become equal. Then, the signal processing device 100 sets probability parameters for the respective clusters (step S101). The processing of step S101 may be executed by the parameter calculation unit 120 of the signal processing device 100.

Next, the pixel assignment unit 110 assigns, for each pixel of the SAR image, the pixel to any one of clusters in such a way as to maximize the complex metric (step S102). That is, the pixel assignment unit 110 creates a plurality of clusters. The pixel assignment unit 110 stores, based on assignment results, assignment information that indicates pixels assigned to clusters in the assignment information storage unit 130.

Next, the parameter calculation unit 120 calculates, for each cluster, the probability parameter in such a way as to maximize the complex metric for all pixels assigned to the cluster (step S103). The parameter calculation unit 120 stores, based on calculation results, parameter information that indicates probability parameters for each cluster in the parameter information storage unit 140.

Next, the signal processing device 100 determines whether a predetermined termination condition is satisfied (step S104). When the predetermined termination condition is not satisfied, the signal processing device 100 returns to the processing of step S102. When the predetermined termination condition is satisfied, the output unit 150 outputs the assignment information stored in the assignment information storage unit 130 and the parameter information stored in the parameter information storage unit 140 (step S105). Thereafter, the signal processing device 100 ends the processing.

The predetermined termination condition is satisfied, for example, when the processing of steps S102 to S103 has been executed a predetermined number of times. The predetermined termination condition may be regarded as satisfied when shapes of respective clusters created by the processing of step S102 have no significant difference compared with shapes of respective clusters created by the processing executed previously in a previous processing loop. The predetermined termination condition may also be regarded as satisfied when probability parameters of respective clusters calculated by the processing of step S103 have no significant difference compared with probability parameters calculated in the previous processing loop.

Each cluster determined when the predetermined termination condition is satisfied corresponds to a cluster that satisfies a criterion for determining homogeneity. That is, this cluster is a pixel group having variation following the same probability distribution.

As explained above, by repeatedly executing the processing of steps S102 to S103, the signal processing device 100 can divide pixels of a complex image into clusters similar in phase, intensity, and manner of noise. This corresponds to extracting a pixel group from a complex image.

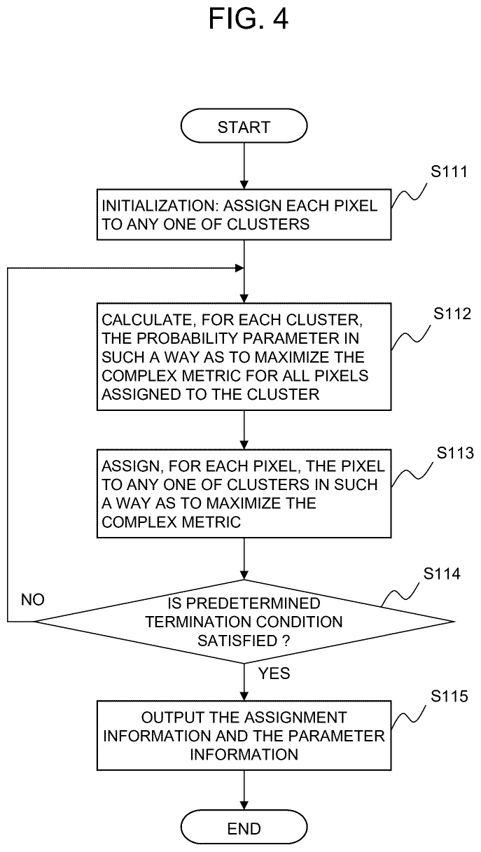

Next, another example of operation of the signal processing device 100 is explained with reference to FIG. 4. FIG. 4 is a flowchart that explains another example of operation of the signal processing device 100.

The signal processing device 100 inputs a plurality of aligned SAR images and, as initialization processing, assigns each pixel to any one of clusters (step S111). That is, the signal processing device 100 divides SAR images into a plurality of initial clusters. A way of division is arbitrary. As one example, the signal processing device 100 creates a plurality of initial clusters in such a way that areas of clusters become equal. The processing of step S111 may be executed by the pixel assignment unit 110 of the signal processing device 100.

Next, the parameter calculation unit 120 calculates, for each cluster, the probability parameter in such a way as to maximize the complex metric for all pixels assigned to the cluster (step S112). The parameter calculation unit 120 stores, based on calculation results, parameter information that indicates probability parameters for each cluster in the parameter information storage unit 140.

Next, the pixel assignment unit 110 assigns, for each pixel of the SAR image, the pixel to any one of clusters in such a way as to maximize the complex metric (step S113). That is, the pixel assignment unit 110 creates a plurality of clusters. The pixel assignment unit 110 stores, based on assignment results, assignment information that indicates pixels assigned to clusters in the assignment information storage unit 130.

Next, the signal processing device 100 determines whether a predetermined termination condition is satisfied (step S114). The signal processing device 100 can apply, for example, the same predetermined termination condition as in the example of operation shown in FIG. 3. When the predetermined termination condition is not satisfied, the signal processing device 100 returns to the processing of step S112. When the predetermined termination condition is satisfied, the output unit 150 outputs the assignment information stored in the assignment information storage unit 130 and the parameter information stored in the parameter information storage unit 140 (step S115). Thereafter, the signal processing device 100 ends the processing.

Note that the examples of operation shown in FIG. 3 and FIG. 4 do not limit operation of the signal processing device 100 of the present disclosure.

For example, when searching which cluster to assign a pixel to, the pixel assignment unit 110 may limit clusters to be searched based on position information of the pixel. For example, when a pixel position that is a centroid of each cluster is specified, the pixel assignment unit 110 may, for each pixel, search only clusters having centroids within a certain distance from the pixel position. By limiting clusters to be searched, the number of computations related to the complex metric can be reduced, and operation of the pixel assignment unit 110 can be accelerated. Also, for example, cluster candidates to which each pixel can be assigned may be predetermined in accordance with the position of the pixel. In this case, cluster candidates corresponding to each pixel may be ones that are not changed in a process of optimization computations of steps S102 to S103 and S112 to S113.

Next, effects of the present example embodiment are explained. In the present example embodiment, the pixel assignment unit 110 assigns, for each pixel of a complex image, the pixel to a cluster in such a way as to maximize a complex metric indicating a degree of match between a complex vector and a probability parameter of a cluster. The parameter calculation unit 120 calculates, for each cluster, the probability parameter in such a way as to maximize the complex metric for all pixels assigned to the cluster. The pixel assignment unit 110 and the parameter calculation unit 120 operate alternately until a predetermined termination condition is satisfied. Each cluster determined when the predetermined termination condition is satisfied corresponds to a cluster that satisfies a criterion for determining homogeneity. In other words, pixels of a complex image are divided into clusters similar in phase, intensity, and manner of noise. With such a configuration, the signal processing device 100 can suitably extract a pixel group having variation following the same probability distribution from a complex image.

By using the complex metrics explained above, the signal processing device 100 performs processing using a probability distribution based on pixel values expressed as complex numbers. As a result, clusters including pixels whose magnitudes of phase means and phase variances are uniform are created. In this way, the signal processing device 100 can improve noise tolerance of clusters.

Also, in extracting a pixel group, the signal processing device 100 does not need to execute processing to compare, for each of a large number of pixels of interest, with all pixels in a window, like the pixel identification device described in Patent Literature 1. Therefore, the signal processing device 100 can rapidly extract a pixel group having variation following the same probability distribution from a complex image.

The pixel group extracted by the signal processing device 100 is utilized in various ways. For example, the pixel group is used in a field of interferometric analysis that analyzes displacement, elevation, and the like based on a phase difference among a plurality of SAR images. Specifically, the pixel group can be used as a pixel group to be averaged when calculating an average phase with reduced amount and influence of noise included in a phase difference. By utilizing in this way, high-accuracy displacement analysis becomes possible even in a region with high noise.

The pixel group is also used in a field of change detection that detects a change or an anomaly on the ground based on a change in intensity. Specifically, the pixel group can be used as a plurality of samples to estimate a distribution of noise amount and the like for the purpose of calculating a noise amount and the like of pixel values that can be observed in normal times with no change. By utilizing in this way, highly reliable change detection becomes possible.

By grouping a plurality of pixels with similar distributions, the group can be regarded as a group of pixels, that is, a super pixel, likely to image the same object. By analyzing based on differences between such pixel groups, faster analysis such as segmentation becomes possible.

### Example Embodiment 2

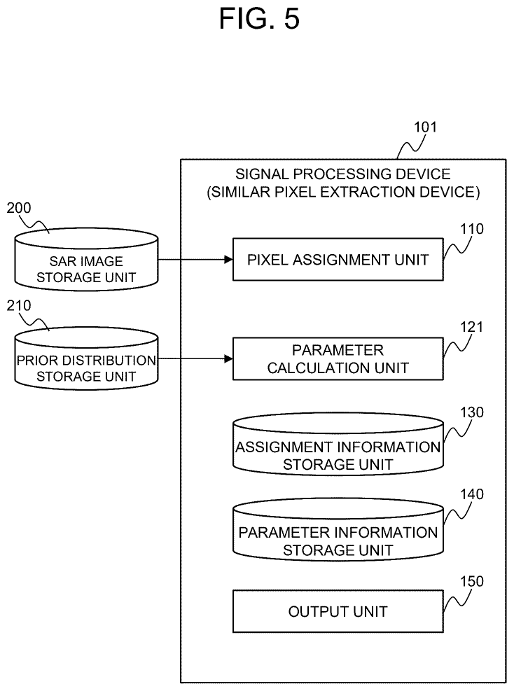

FIG. 5 is a block diagram that shows a signal processing device 101 of another example embodiment. The signal processing device 101 includes the pixel assignment unit 110, a parameter calculation unit 121, the assignment information storage unit 130, the parameter information storage unit 140, and the output unit 150. The signal processing device 101 can input SAR images from the SAR image storage unit 200. Note that the SAR image storage unit 200 and a prior distribution storage unit 210 may be included in the signal processing device 100 or may be included in a device different from the signal processing device 100. Functions of respective components other than the parameter calculation unit 121 in the signal processing device 101 are the same as functions of respective components in the signal processing device 100 shown in FIG. 1. Below, portions different from Example Embodiment 1 are mainly explained and explanation of the same portions is omitted.

The parameter calculation unit 121 can input, from the prior distribution storage unit 210, data indicating a prior distribution for probability parameters of clusters. The parameter calculation unit 121 calculates probability parameters by using this prior distribution. The prior distribution is expressed, for example, by Equation (5) below. Note that Equation (5) below is one example of a prior distribution. The parameter calculation unit 121 can use various other forms of prior distributions without being limited to the form shown in Equation (5).

$$\begin{matrix}[ Math . 5 ] & \\ p ( {Γ}_{c} \vert Ψ , v ) = \frac{1}{z} {\vert {Γ}_{c} \vert}^{- ( v + p )} {e}^{- tr ( {ΨΓ}_{c}^{- 1} )} & Equation ( 5 )\end{matrix}$$

The prior distribution of Equation (5) is a distribution that is assumed in advance for a probability parameter Gamma_c of cluster c and indicates an a priori assumption as to what values Gamma_c can take. The prior distribution of Equation (5) is obtained by substituting Gamma_c for x in a formula defined by a Complex Inverse Wishart Distribution and summarizing a part independent of Gamma_c into Z, and is a conjugate prior distribution to Equation (2). Therefore, by using the prior distribution of Equation (5) together with Equation (2), computation to obtain an optimal Gamma_c becomes easy. Note that a Complex Inverse Wishart Distribution is a conjugate prior distribution to Equation (2), and a Complex Wishart Distribution is a conjugate prior distribution to Equation (3), and in both cases computation becomes easy when used together. However, a form of a prior distribution is not limited to a conjugate prior distribution. The parameter calculation unit 121 may use a prior distribution other than a conjugate prior distribution.

A way to define parameters of the prior distribution is arbitrary. For example, parameters of the prior distribution may be defined according to a user input operation. A computer such as the signal processing device 101 may determine, by using all pixels of input SAR images, a value corresponding to Gamma_c and reflect a determination result in parameters of the prior distribution.

When calculating a covariance matrix Gamma_c based on actual data, a calculation result may become unstable, in particular when data is small or variation among samples is large. Therefore, the signal processing device 101 alleviates this instability by using a prior distribution.

In the present example embodiment, the parameter calculation unit 121 calculates probability parameters by using a prior distribution for probability parameters. With such a configuration, in addition to the effects of Example Embodiment 1, an effect is achieved that calculation of probability parameters can be stably performed.

Below, concrete examples of a signal processing system to which the signal processing devices (similar pixel extraction devices) realized by the above example embodiments are applied are explained.

### Example 1

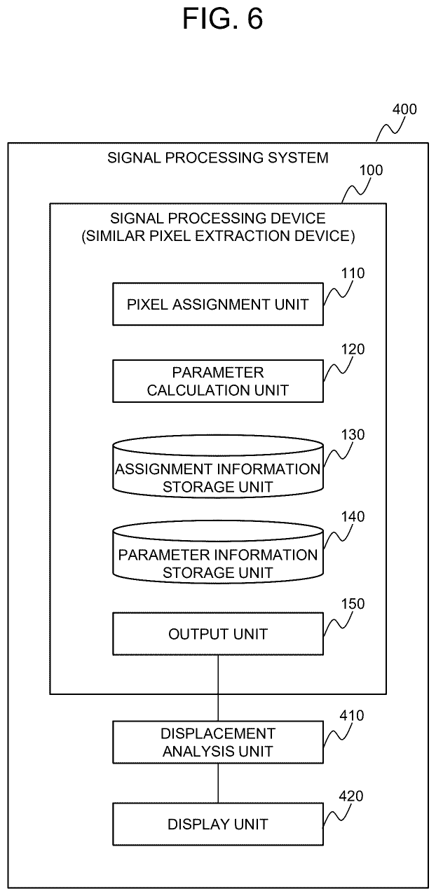

FIG. 6 is a block diagram that shows a signal processing system of a first example. A signal processing system 400 of the first example includes the signal processing device 100, a displacement analysis unit 410, and a display unit 420. Note that the signal processing device 101 may be used in place of the signal processing device 100. In Example 2 below, the signal processing device 101 may also be used. The signal processing system 400 may be realized by a single device.

The displacement analysis unit 410 has a function to perform analysis of the cluster by using probability parameters of the cluster. For example, the displacement analysis unit 410 inputs the assignment information and the parameter information output from the output unit 150 of the signal processing device 100. The displacement analysis unit 410 analyzes displacement, elevation, and the like for each cluster by using probability parameters of clusters.

The display unit 420 is realized by a display device such as a display device. The displacement analysis unit 410 displays an analysis result of a cluster at positions of pixels belonging to the cluster. For example, the displacement analysis unit 410 controls in such a way as to display, on the display unit 420, analysis results for respective clusters at positions of pixels assigned to the clusters.

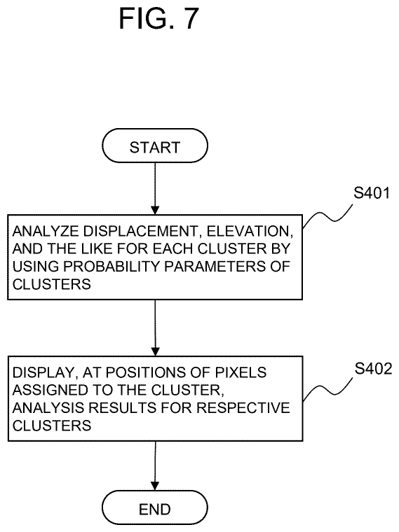

Next, the signal processing system of the present example is explained. FIG. 7 is a flowchart that exemplifies operation of the signal processing system 400. Note that, in the flowchart shown in FIG. 7, operation of the signal processing device 100 exemplified in FIG. 3 and FIG. 4 is omitted.

The displacement analysis unit 410 inputs the assignment information and the parameter information output from the output unit 150 of the signal processing device 100. The displacement analysis unit 410 analyzes displacement, elevation, and the like for each cluster by using probability parameters of clusters (step S401).

Next, the display unit 420 displays, at positions of pixels assigned to the cluster, analysis results for respective clusters by the displacement analysis unit 410 (step S402). For example, the displacement analysis unit 410 controls in such a way as to display, on the display unit 420, analysis results for respective clusters at positions of pixels assigned to the clusters.

### Example 2

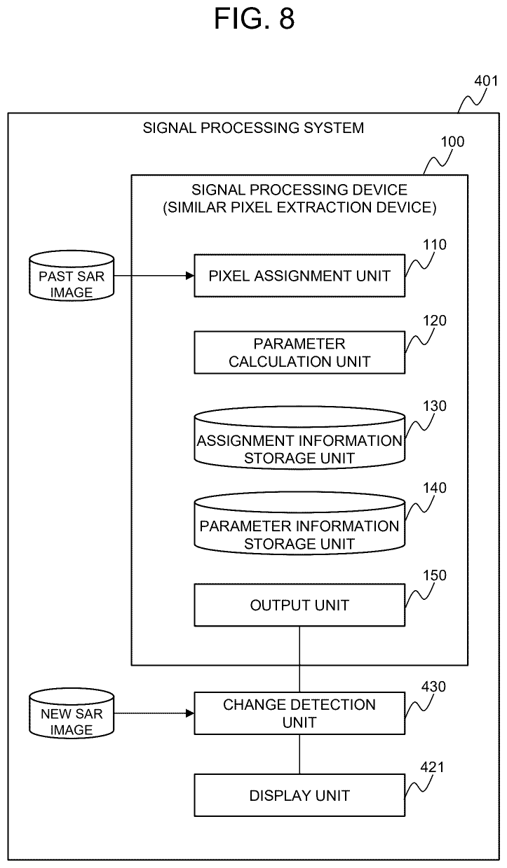

FIG. 8 is a block diagram that shows a signal processing system of a second example. A signal processing system 401 of the second example includes the signal processing device 100, a change detection unit 430, and a display unit 421. Note that the signal processing system 401 may be realized by a single device.

The change detection unit 430 has a function to perform change detection of the cluster by using probability parameters of the cluster. For example, the change detection unit 430 inputs the assignment information and the parameter information output from the output unit 150 of the signal processing device 100. The change detection unit 430 performs change detection for each cluster by using probability parameters of clusters.

The signal processing system 401 can input a new SAR image related to a past SAR image in which a pixel group has been extracted by the signal processing device 100, that is, in which clusters have been created. In this case, the signal processing system 401 may input the new SAR image not to the signal processing device 100 but to the change detection unit 430. The change detection unit 430 may perform change detection for each cluster between the past SAR image and the new SAR image by using the assignment information and the parameter information based on the past SAR image.

The display unit 421 is realized by a display device such as a display device. The change detection unit 430 displays a change detection result of a cluster at positions of pixels belonging to the cluster. For example, the change detection unit 430 controls in such a way as to display, on the display unit 421, change detection results for respective clusters at positions of pixels assigned to the clusters.

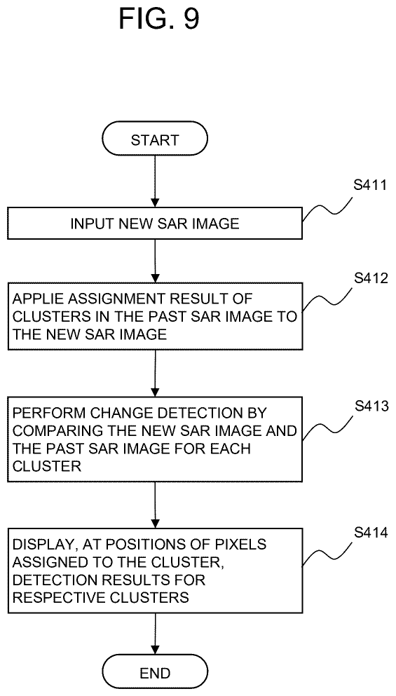

Next, the signal processing system of the present example is explained. FIG. 9 is a flowchart that exemplifies operation of the signal processing system 401. Note that, in the flowchart shown in FIG. 9, operation of the signal processing device 100 exemplified in FIG. 3 and FIG. 4 is omitted.

The signal processing system 401 inputs a new SAR image related to a past SAR image in which a pixel group has been extracted by the signal processing device 100, that is, in which clusters have been created (step S411).

Next, the change detection unit 430 applies an assignment result of clusters in the past SAR image to the new SAR image (step S412).

Next, the change detection unit 430 performs change detection by comparing the new SAR image and the past SAR image for each cluster (step S413).

Next, the display unit 421 displays, at positions of pixels assigned to the cluster, detection results for respective clusters by the change detection unit 430 (step S414). For example, the change detection unit 430 controls in such a way as to display, on the display unit 421, detection results for respective clusters at positions of pixels assigned to the clusters.

Note that the examples of operation shown in FIG. 7 and FIG. 9 do not limit operation of the signal processing system of the present disclosure.

As explained above, the signal processing device 100 and the signal processing device 101 of the above example embodiments can suitably and rapidly extract, from a complex image, a plurality of pixels having variation following the same probability distribution. That is, a plurality of pixels having variation following the same probability distribution are grouped as a small number of clusters. Therefore, in the above examples, analysis such as displacement analysis, land cover classification, and anomaly detection can be suitably and rapidly performed by replacing per-pixel analysis with per-cluster analysis.

Note that, although SAR images are used as images in the above example embodiments and examples, the above example embodiments and examples are applicable to an image or a point cloud in which distribution characteristics differ for each pixel, as long as they are such images or point clouds.

Each component in the above example embodiments and examples can be configured by one piece of hardware, but can also be configured by one piece of software. Each component can be configured by a plurality of hardware pieces and can also be configured by a plurality of software pieces. Some of the components can be configured by hardware and others can be configured by software.

Each function (each process) in the above example embodiments can be realized by a computer having a processor and a memory and the like. For example, a program for executing the methods (processes) in the above example embodiments may be stored in a storage device (storage medium), and each function may be realized by executing, by a processor, a program stored in the storage device.

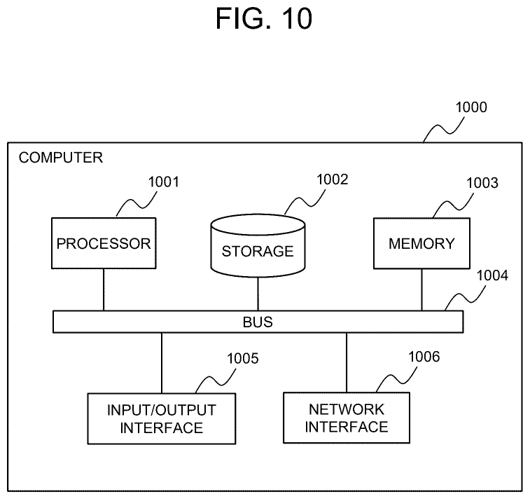

FIG. 10 is a block diagram that exemplifies a hardware configuration of a computer 1000. The computer 1000 is any computer. For example, the computer 1000 is a stationary computer such as a personal computer or a server machine. For example, the computer 1000 is a portable computer such as a smartphone or a tablet terminal. The computer 1000 may be a dedicated computer designed to realize a signal processing device or a signal processing system, or may be a general-purpose computer.

The computer 1000 has a processor 1001, a storage device 1002, a memory 1003, a bus 1004, an input and output interface 1005, and a network interface 1006.

The processor 1001 is various processing devices such as a CPU (Central Processing Unit), a GPU (Graphics Processing Unit), an FPGA (Field-Programmable Gate Array), and a DSP (Digital Signal Processor).

The storage device 1002 is, for example, a non-transitory computer readable medium. The non-transitory computer readable medium includes various types of tangible storage media. Concrete examples of the non-transitory computer readable medium include semiconductor memories such as a mask ROM, a PROM (Programmable ROM), an EPROM (Erasable PROM), and a flash ROM.

The memory 1003 is a main storage device realized using, for example, a RAM (Random Access Memory). The memory 1003 temporarily stores data when the processor 1001 executes processing.

The bus 1004 is a data transmission path for the processor 1001, the memory 1003, the storage device 1002, the input and output interface 1005, and the network interface 1006 to send and receive data to and from each other. However, a method of connecting the processor 1001 and the like to each other is not limited to bus connection.

The input and output interface 1005 is an interface to connect the computer 1000 and input and output devices. For example, an input device such as a keyboard and an output device such as a display device are connected to the input and output interface 1005.

The network interface 1006 is an interface to connect the computer 1000 to a network. The network may be a LAN (Local Area Network) or may be a WAN (Wide Area Network).

The storage device 1002 stores a program for realizing respective functional components in the above example embodiments and examples. The processor 1001 realizes respective functional components in the above example embodiments and examples by reading and executing this program into the memory 1003.

The signal processing device 100, 101 and the signal processing system 400, 401 may be realized by one computer 1000 or may be realized by a plurality of computers 1000. In the latter case, configurations of respective computers 1000 need not be the same and can be different from each other.

Each functional component in the above example embodiments and examples may be realized by a combination of hardware and software explained above or may be realized by hardware such as a hard-wired electronic circuit.

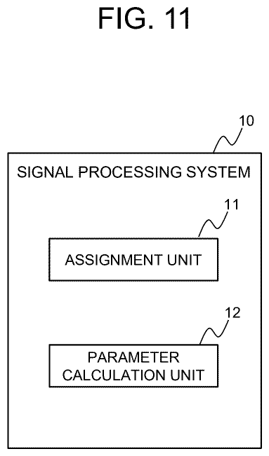

Next, an outline of the present disclosure is explained. FIG. 11 is a block diagram that exemplifies principal parts of a signal processing system. A signal processing system 10 shown in FIG. 11 (for example, realized by the signal processing device 100 or the signal processing device 101, the signal processing system 400, or the signal processing system 401) includes an assignment unit 11 (realized, in the example embodiments, by the pixel assignment unit 110) that assigns each pixel to a cluster in such a way as to maximize a complex metric that indicates a degree of match between a complex vector obtained from corresponding pixels of a plurality of complex images and a probability parameter of a cluster, and a parameter calculation unit 12 (realized, in the example embodiments, by the parameter calculation unit 120 or the parameter calculation unit 121) that calculates, for each cluster, the probability parameter in such a way as to maximize the complex metric for all pixels assigned to the cluster, wherein the assignment unit 11 and the parameter calculation unit 12 operating alternately. With such a configuration, the signal processing system 10 can suitably extract a pixel group having variation following the same probability distribution from a complex image.

By using the complex metrics explained above, the signal processing system 10 performs processing using a probability distribution based on pixel values expressed as complex numbers. As a result, clusters including pixels whose magnitudes of phase means and phase variances are uniform are created. In this way, the signal processing system 10 can improve noise tolerance of clusters.

In extracting a pixel group, the signal processing system 10 does not need to execute processing to compare, for each of a large number of pixels of interest, with all pixels in a window, like the pixel identification device described in Patent Literature 1. Therefore, the signal processing system 10 can rapidly extract a pixel group having variation following the same probability distribution from a complex image.

The present disclosure has been explained with reference to example embodiments, but the present disclosure is not limited to the above example embodiments. Various changes can be made to configurations and details within a scope of the present disclosure that can be understood by those skilled in the art. Each example embodiment can be combined with another example embodiment as appropriate.

The drawings are merely illustrative to explain one or more example embodiments. The drawings are not associated only with one specific example embodiment but may be associated with one or more other example embodiments. As can be understood by those skilled in the art, various features or steps explained with reference to any one of the drawings can be combined with features or steps shown in one or more other drawings to create an example embodiment that is not explicitly illustrated or explained. All the features or steps shown in any one drawing are not necessarily essential to explain an example embodiment, and some features or steps may be omitted. An order of steps described in any drawing may be changed as appropriate.

Some or all of the above example embodiments can also be written as below appended notes, but are not limited thereto.

### (Supplementary Note 1)

A signal processing system including:
an assignment unit that assigns each pixel to a cluster in such a way as to maximize a complex metric that indicates a degree of match between a complex vector obtained from corresponding pixels of a plurality of complex images and a probability parameter of a cluster; and
a parameter calculation unit that calculates, for each cluster, the probability parameter in such a way as to maximize the complex metric for all pixels assigned to the cluster,
wherein the assignment unit and the parameter calculation unit operate alternately.

### (Supplementary Note 2)

The signal processing system according to Supplementary note 1, wherein
the complex metric is a 0-mean multivariate complex Gaussian distribution, and
the probability parameter is a variance-covariance matrix of the multivariate complex Gaussian distribution or an inverse matrix of the variance-covariance matrix.

### (Supplementary Note 3)

The signal processing system according to Supplementary note 1 or 2, wherein
The probability parameter is an inverse matrix of a variance-covariance matrix and a part of the inverse matrix is constrained to zero.

### (Supplementary Note 4)

The signal processing system according to any one of Supplementary notes 1 to 3, wherein
the complex vector has a number of elements equal to a number of inputs obtained from respective corresponding pixels when a plurality of aligned complex images are input.

### (Supplementary Note 5)

The signal processing system according to any one of Supplementary notes 1 to 4, wherein
the parameter calculation unit calculates the probability parameter by using a prior distribution for the probability parameter.

### (Supplementary Note 6)

The signal processing system according to any one of Supplementary notes 1 to 5, further including
an output unit that outputs at least one of information indicating pixels assigned to a cluster and information indicating the probability parameter of the cluster.

### (Supplementary Note 7)

The signal processing system according to any one of Supplementary notes 1 to 6, further including
an interferometric analysis unit that performs analysis of the cluster by using the probability parameter of the cluster.

### (Supplementary Note 8)

The signal processing system according to Supplementary note 7, further including
a display unit that displays an analysis result of the cluster by the interferometric analysis unit at positions of pixels assigned to the cluster.

### (Supplementary Note 9)

A signal processing method performed by a computer includes:
assigning each pixel to a cluster in such a way as to maximize a complex metric that indicates a degree of match between a complex vector obtained from corresponding pixels of a plurality of complex images and a probability parameter of a cluster;
calculating, for each cluster, the probability parameter in such a way as to maximize the complex metric for all pixels assigned to the cluster; and
alternately performing the assigning and the calculating.

### (Supplementary Note 10)

A signal processing program for causing a computer to execute:
assigning each pixel to a cluster in such a way as to maximize a complex metric that indicates a degree of match between a complex vector obtained from corresponding pixels of a plurality of complex images and a probability parameter of a cluster;
calculating, for each cluster, the probability parameter in such a way as to maximize the complex metric for all pixels assigned to the cluster; and
alternately performing the assigning and the calculating.

### (Supplementary Note 11)

A non-transitory computer readable recording medium storing a signal processing program executable by a computer to perform processing including:
assigning each pixel to a cluster in such a way as to maximize a complex metric that indicates a degree of match between a complex vector obtained from corresponding pixels of a plurality of complex images and a probability parameter of a cluster;
calculating, for each cluster, the probability parameter in such a way as to maximize the complex metric for all pixels assigned to the cluster; and
alternately performing the assigning and the calculating.

Some or all of the elements (for example, configuration and function) described in Supplementary notes 2 to 8, which are dependent on Supplementary note 1, may also be dependent on Supplementary notes 9, 10 and 11 with the same dependency relationship as in Supplementary notes 2 to 8. Some or all of the elements described in any Supplementary note may be applied to various hardware, software, recording means for recording software, systems, and methods.

1. A signal processing system comprising:
a memory storing software instructions; and
one or more processors configured to execute the software instructions to:
assign each pixel to a cluster in such a way as to maximize a complex metric that indicates a degree of match between a complex vector obtained from corresponding pixels of a plurality of complex images and a probability parameter of a cluster;
calculate, for each cluster, the probability parameter in such a way as to maximize the complex metric for all pixels assigned to the cluster; and
alternately perform the assigning and the calculating.

2. The signal processing system according to claim 1, wherein
the complex metric is a 0-mean multivariate complex Gaussian distribution, and
the probability parameter is a variance-covariance matrix of the multivariate complex Gaussian distribution or an inverse matrix of the variance-covariance matrix.

3. The signal processing system according to claim 2, wherein
The probability parameter is an inverse matrix of a variance-covariance matrix and a part of the inverse matrix is constrained to zero.

4. The signal processing system according to claim 1, wherein
the complex vector has a number of elements equal to a number of inputs obtained from respective corresponding pixels when a plurality of aligned complex images are input.

5. The signal processing system according to claim 1, wherein
the one or more processors are configured to execute the software instructions to calculate the probability parameter by using a prior distribution for the probability parameter.

6. The signal processing system according to claim 1, wherein the one or more processors are further configured to execute the software instructions to
output at least one of information indicating pixels assigned to a cluster and information indicating the probability parameter of the cluster.

7. The signal processing system according to claim 1, wherein the one or more processors are further configured to execute the software instructions to
perform analysis of the cluster by using the probability parameter of the cluster.

8. The signal processing system according to claim 7, wherein the one or more processors are further configured to execute the software instructions to
display an analysis result of the cluster at positions of pixels assigned to the cluster.

9. A signal processing method performed by a computer and comprising:
assigning each pixel to a cluster in such a way as to maximize a complex metric that indicates a degree of match between a complex vector obtained from corresponding pixels of a plurality of complex images and a probability parameter of a cluster;
calculating, for each cluster, the probability parameter in such a way as to maximize the complex metric for all pixels assigned to the cluster; and
alternately performing the assigning and the calculating.

10. A non-transitory computer readable medium storing a signal processing program executable by a computer to perform processing comprising:
assigning each pixel to a cluster in such a way as to maximize a complex metric that indicates a degree of match between a complex vector obtained from corresponding pixels of a plurality of complex images and a probability parameter of a cluster;
calculating, for each cluster, the probability parameter in such a way as to maximize the complex metric for all pixels assigned to the cluster; and
alternately performing the assigning and the calculating.

11. The signal processing system according to claim 2, wherein
the complex vector has a number of elements equal to a number of inputs obtained from respective corresponding pixels when a plurality of aligned complex images are input.

12. The signal processing system according to claim 2, wherein
the one or more processors are configured to execute the software instructions to calculate the probability parameter by using a prior distribution for the probability parameter.

13. The signal processing system according to claim 2, wherein the one or more processors are further configured to execute the software instructions to
output at least one of information indicating pixels assigned to a cluster and information indicating the probability parameter of the cluster.

14. The signal processing system according to claim 2, wherein the one or more processors are further configured to execute the software instructions to
perform analysis of the cluster by using the probability parameter of the cluster.

15. The signal processing system according to claim 14, wherein the one or more processors are further configured to execute the software instructions to
display an analysis result of the cluster at positions of pixels assigned to the cluster.
